(19) United States
(12) Patent Application Publication
(10) Pub. No.: US 2013/0138352 A1
(43) Pub. Date: May 30, 2013

(54) SYSTEM AND METHOD FOR DETERMINING A BASELINE MEASUREMENT FOR A BIOLOGICAL RESPONSE CURVE

(71) Applicants: Carlos Edwin Funes, Hayward, CA (US); Evan F. Cromwell, Redwood City, CA (US)

(72) Inventors: Carlos Edwin Funes, Hayward, CA (US); Evan F. Cromwell, Redwood City, CA (US)

(73) Assignee: MOLECULAR DEVICES, LLC, Sunnyvale, CA (US)

(21) Appl. No.: 13/308,021

(22) Filed: Nov. 30, 2011

(51) Int. Cl. G06F 19/10

(52) U.S. Cl. 702/19

(57) ABSTRACT

A system for determining a baseline measurement for a biological curve is provided. A derivation module determines a derivative response curve based on the biological response curve. A peak identification module searches the derivate response curve to identify a peak in the biological response curve. A leading baseline identification module searches the derivative response curve to identify a starting position of the peak and identifies a leading baseline in the biological response curve. The leading baseline is identified based at least in part on the starting position of the peak. A baseline determination module determines a baseline measurement for the biological response curve based at least in part on the leading baseline associated with the peak.

### FIELD OF THE INVENTION

The present invention relates to cellular assay systems and in particular systems for analyzing biological response data.

### BACKGROUND

Researchers may use cellular assay screening systems to acquire biological response data. Researches may then plot the biological response data on a graph to obtain a biological response curve. Peaks and troughs in the biological response curve may give the curve a unique shape profile. Uniquely-shaped biological response curves may result where biological responses are cyclical, oscillate, or have regular or irregular variations in magnitude. Peaks in the biological response curve may correspond to action potentials that occur during the biological assay.

It is often desirable to measure the properties of action potentials in a biological response curve. Action potential properties include, for example, rise time, decay time, and other shape-related properties. In order to obtain reliable results, it is advantageous to use a reliable baseline measurement when measuring action potential properties. A baseline is a region in the biological response curve where the response is at rest.

A portion of an example biological response curve 100 is shown in FIG. 1. The portion of the biological response curve, in this example, includes an action potential 102. The action potential 102 includes a rise 104 that increases to form a peak 106, which is followed by a decay 108 that decreases to form a trough 110. The biological response curve 100, in this example, then returns to a baseline 112 following the action potential 102. The steady state region that precedes the action potential 102 may be referred to as the leading baseline 114 for the action potential 102.

Determining a reliable baseline measurement, however, can be difficult. One known approach to determining a baseline measurement analyzes the respective troughs between action potentials in order to identify a region in which to calculate a baseline measurement.

Another known approach identifies a trough in the biological response curve as the region between the greatest positive change and the greatest negative change in the derivative of the biological response curve. These approaches, however, may not produce reliable baseline measurements due to the diverse shape profiles biological response curves may exhibit, e.g., action potentials having a two-step decay profile versus action potentials having a one-step decay profile.

Therefore, a need exists for a new approach to determining a reliable baseline measurement that is suitable for a variety of biological response curve shape profiles.

### SUMMARY

A computer-implemented method of determining a baseline measurement for a biological response curve is provided. A derivative response curve is determined based on the biological response curve. The derivative response curve is searched to identify a peak in the biological response curve. The derivative response curve is also searched to identify a starting position of the peak. A leading baseline in the biological response curve is identified. The leading baseline is associated with the peak and is identified based at least in part on the starting position of the peak. A baseline measurement for the biological response curve is determined based at least in part on the leading baseline associated with the peak.

A system for determining a baseline measurement for a biological curve is also provided. A derivation module determines a derivative response curve based on the biological response curve. A peak identification module searches the derivate response curve to identify a peak in the biological response curve. A leading baseline identification module searches the derivative response curve to identify a starting position of the peak and identifies a leading baseline in the biological response curve. The leading baseline is associated with the peak and is identified based at least in part on the starting position of the peak. A baseline determination module determines a baseline measurement for the biological response curve based at least in part on the leading baseline associated with the peak.

### BRIEF DESCRIPTION OF THE DRAWINGS

FIG. 1 is an example of a biological response curve that includes a baseline and an action potential.

FIG. 2 is an example of an implementation of a system for determining a baseline measurement in a biological response curve.

FIG. 3 is a flowchart of example method steps for determining a baseline measurement in a biological response curve.

FIG. 4A is an example of a raw biological response curve.

FIG. 4B is an example of a derivative biological response curve of the raw biological response curve in FIG. 4A.

FIG. 5A is a subsection of the raw biological response curve in FIG. 4A.

FIG. 5B is a subsection of the derivative biological response curve in FIG. 4B.

FIG. 6 is a flow chart of example method steps for identifying a peak in a derivative biological response curve.

FIG. 7 is a flow chart of example method steps for identifying a leading baseline for an action potential.

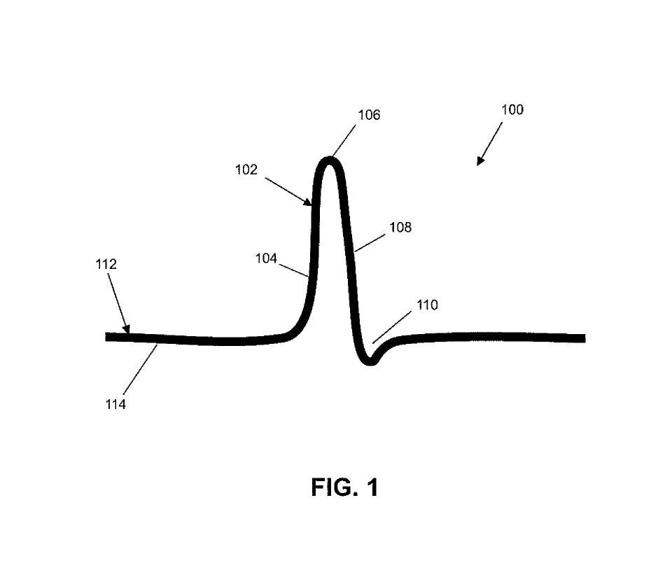

### DETAILED DESCRIPTION

As described in further detail below, a baseline measurement for a biological response curve is determined based on a derivative of the biological response curve. In particular, the baseline measurement is determined by focusing on discrete locations in the biological response curve and in the derivative of the biological response curve. By focusing on discrete locations, interference from the decay of previous action potentials (or other biological responses) can be minimized. Using this approach advantageously provides a reliable baseline measurement across a variety of shape profiles for biological response curves. In turn, the reliable baseline measurement provided advantageously improves the reliability of measurements relating to biological responses (e.g., action potentials) in the biological response curve.

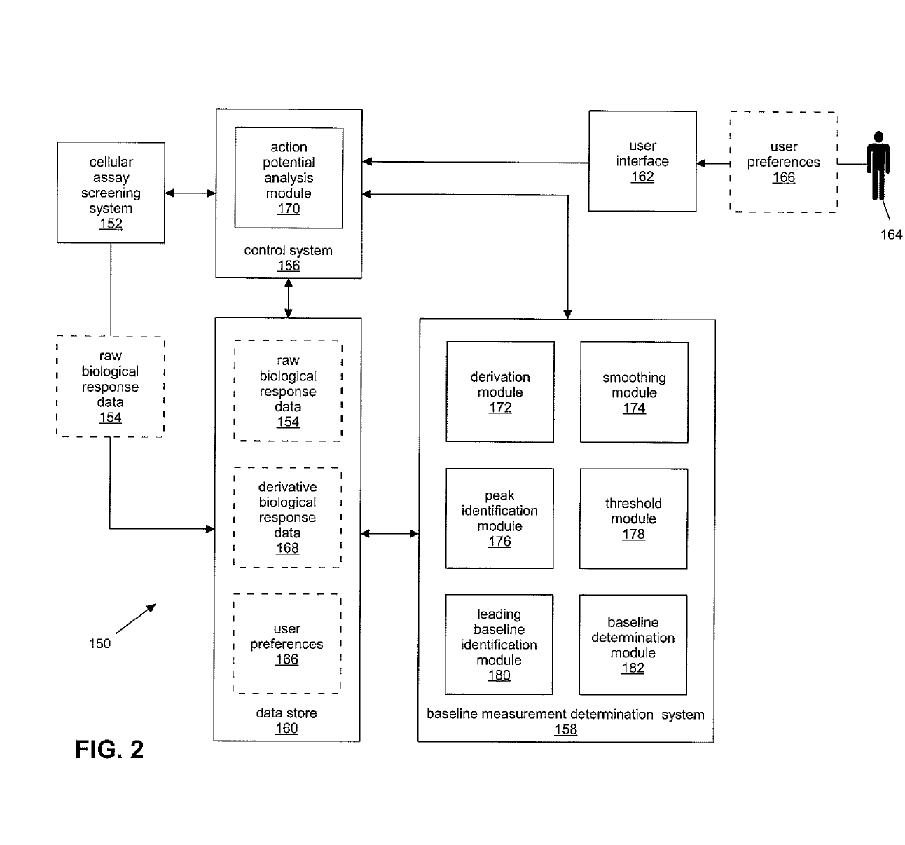

Referring to FIG. 2, a system 150 for determining a baseline measurement for a biological response curve is shown. The system 150, in this example, includes: a cellular assay screening system 152 that analyzes biological responses and generates raw biological response data 154; a control system 156 that controls operation of the cellular assay screening system 152 and analyzes the resulting biological response data 154; a baseline measurement determination system 158 that determines a baseline measurement for a biological response curve; and a data store 160 that stores the raw biological response data 154 and other information related to determining a baseline measurement for a biological response curve. The system 150 may also include a user interface 162 for receiving user input from a user 164. User input may include, for example, user preferences 166 used when determining a baseline measurement for a biological response curve. The data store 160 may also store the user preferences 166.

The components of the system 150 are in signal communication with each other and may respectively reside at one or more computing devices. The computing devices may be, for example, desktop computers, laptop computers, tablet computers, palmtop computer, mobile telephones, and the like. The computing devices may include one or more processing units (not shown) configured to execute instructions related to determining a baseline measurement for a biological response curve.

A suitable cellular assay screening system 152 may be, for example, the FLIPR®

Tetra High Throughput Cellular Screening System, which may be available from Molecular Devices, LLC of Sunnyvale, Calif. A suitable control system 156 may be implemented with, for example, ScreenWorks® system control software, which may also be available from Molecular Devices, LLC.

The data store 160, in this example, receives the raw biological response data 154 from the cellular assay screening system 152 and may store the raw biological response data 154 in, for example, a computer memory. As discussed further below, the data store 160 may also store derivative biological response data 168 as well as user preferences 166 received as user input from a user 164.

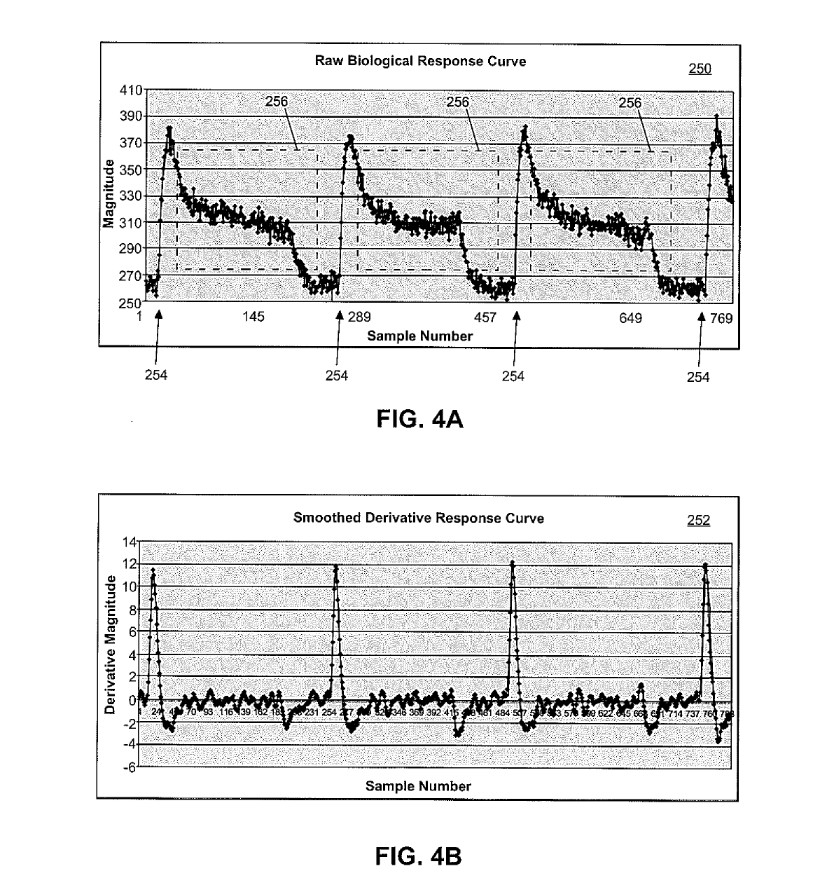

Biological response data 154, in this example, includes a set of samples respectively associated with a magnitude value. For example, a cellular assay screening of five-hundred samples may result in the following the biological response data 154 shown as value pairs of the sample number and associated magnitude, i.e., (sample number, magnitude): [(1, 265), (2, 271), (3, 258), . . . , (23, 290), (24, 310), (25, 350), (26, 385), (27, 370), . . . , (499, 262), (500, 266)]. Magnitude values may represent, for example, fluorescence intensity, electrical impedance, intensity deviation, or other responses measured in biological assays. The sample numbers and magnitude values may be plotted on a graph with the sample numbers plotted along the horizontal x-axis and the magnitude values respectively associated with the sample numbers plotted on the vertical y-axis as shown by way of example below in FIG. 4A.

The control system 156 may receive commands from the user 164 via the user interface 162. Additionally the control system 156 may receive the user preferences 166 via the user interface 162, and the control system 156 may transmit the user preferences 166 to the data store 160 for storage. The control system 156 may also include an action potential analysis module 170 that analyzes action potentials in the biological response curve and measures various properties relating to the action potentials, e.g., rise time, decay time, etc. The action potential analysis module 170 may use the baseline measurement determined by the baseline measurement determination system 158 when analyzing the action potentials.

The baseline measurement determination system 158 includes various modules that facilitate the determination of a baseline measurement for a biological response curve. In this example, the baseline measurement determination system 158 includes: a derivation module 172 that determines the derivative of the raw biological response curve and generates a derivative biological response curve; a smoothing module 174 that smoothes the derivative biological response curve to reduce noise; a peak identification module 176 that identifies peaks in the derivative biological response curve; a threshold module 178 that determines whether an identified peak exceeds a cutoff magnitude threshold; a leading baseline identification module 180 that identifies respective leading baselines for action potentials; and a baseline determination module 182 that determines the baseline measurement for a biological response curve based on the information provided by the accompanying modules.

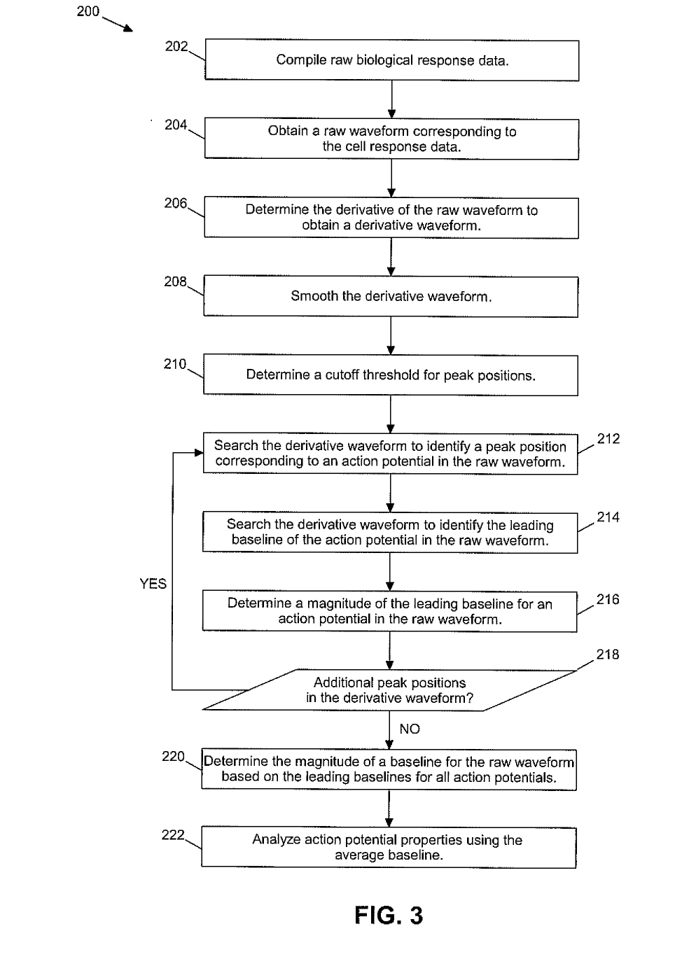

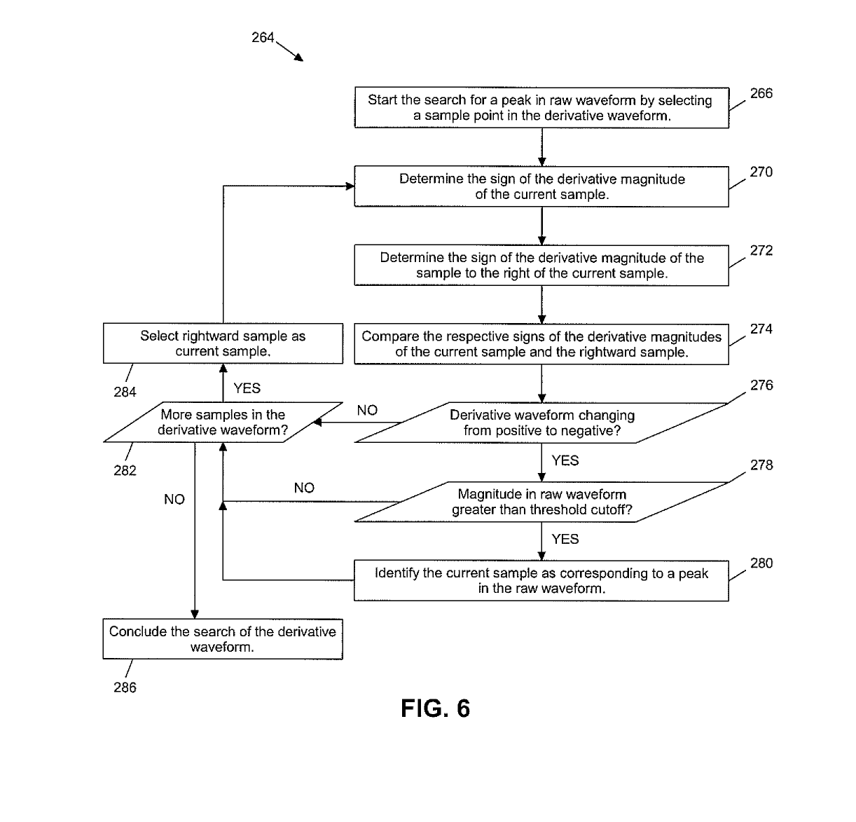

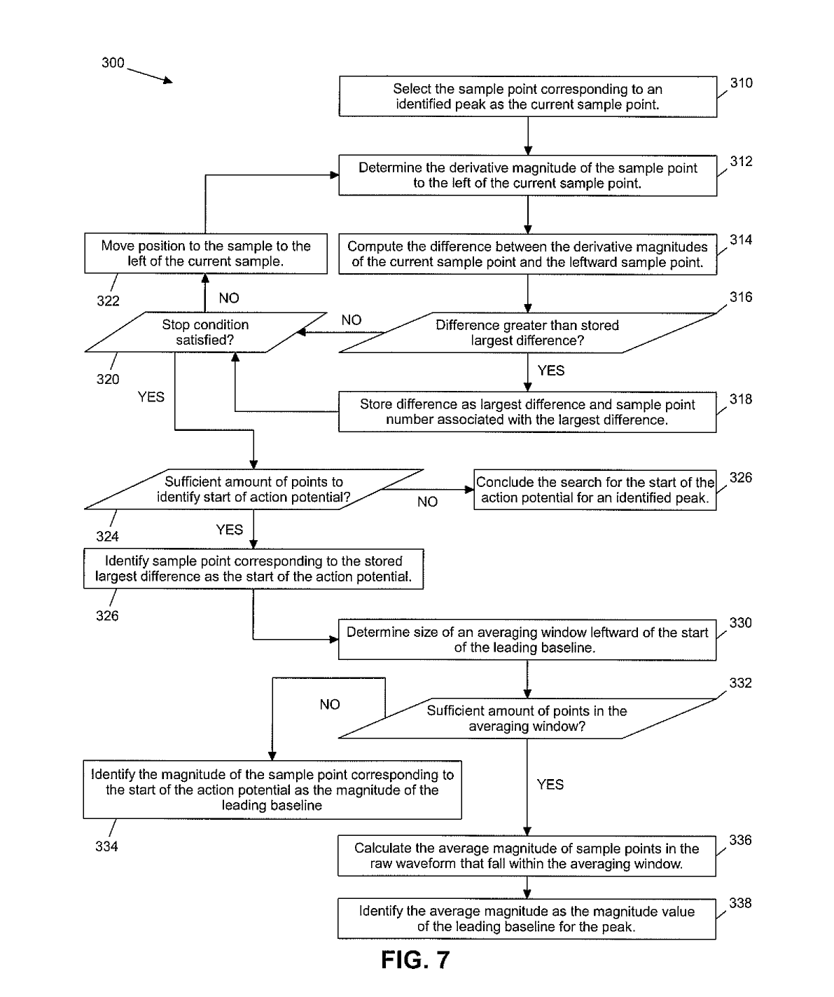

With reference to FIG. 3, a flowchart 200 of example method steps used to determine a baseline measurement for a biological response curve is shown. The steps in FIG. 3 will be discussed with additional reference to FIG. 2 and in further detail below with reference to FIGS. 6-7. As seen in FIG. 3, the cellular assay screening system 152 compiles raw biological response data 154 (step 202). A biological response curve for the raw biological response data 154, i.e., a raw waveform, is obtained (step 204). The derivation module 172 then determines the derivative of the raw waveform to obtain a derivative waveform (step 206). The smoothing module 174 may then smooth the derivative waveform to reduce noise that may be present in the derivative waveform (step 208).

After the smoothing module 174 smoothes the derivative waveform, the threshold module 178 may determine a cutoff magnitude threshold (step 210). The magnitude threshold, in this example, is a minimum magnitude a sample point associated with an identified peak must meet or exceed in order to be considered when determining the baseline measurement for the biological response curve. If the magnitude of an identified peak in the raw waveform is at least equal to (i.e., greater than or equal to) the magnitude threshold, then the threshold module 178 may determine that the peak is associated with an action potential (or other biological response) in the raw waveform. If, however, the magnitude of an identified peak in the raw waveform is not at least equal to the magnitude threshold, then the threshold module 178 may determine that the peak is not associated with an action potential (or other biological response) in the raw waveform. Accordingly the threshold module 178, in this example, uses the cutoff magnitude threshold to filter potential peaks during peak identification.

Once the derivation module 172 has obtained the derivative waveform and once a cutoff magnitude threshold is determined, the peak identification module 176 searches the derivative waveform to identify a peak in the raw waveform (step 212). A peak in the raw waveform is associated with an action potential in the raw waveform. Peaks may also be associated with a particular sample point in the raw and derivative waveforms. The threshold module 178 may filter potential peaks identified by the peak identification module 176 as discussed above. After the peak identification module 176 identifies a peak associated with an action potential, the leading baseline identification module 180 searches the derivative waveform to identify the leading baseline for the action potential (step 214). As discussed further below, identifying the leading baseline for the action potential includes identifying the start of the action potential associated with an identified peak. The start of an action potential may also be associated with a particular sample point in the raw and derivative waveforms. The leading baseline identification module 180, in this example, then determines the average magnitude of the sample points in the raw waveform adjacent to the start of the action potential in order to identify the leading baseline for the action potential (step 216).

If there are additional peak positions in the derivative waveform (step 218), then steps 212-216 may be repeated to identify the leading baselines respectively associated with additional action potentials in the raw waveform.

Once the peaks in the derivative waveform have been identified, the baseline determination module 182 determines an overall baseline measurement for the raw waveform based on the individual leading baseline measurements (step 220) acquired during the analysis of the raw and derivative waveforms. The baseline determination module 182 may, for example, average the respective leading baseline measurements for the action potentials in order to determine the baseline measurement for the raw waveform. The baseline measurement determination system 158 may then provide the baseline measurement for the raw waveform to the action potential analysis module 170 for use when analyzing the action potentials of the biological response curve (step 222). The action potential analysis module 170 may also analyze individual action potentials using individual leading baselines, which may be advantageous when analyzing raw waveforms having a varying baseline, i.e., where the baseline rises or falls between action potentials. Accordingly, step 222 in FIG. 3 may selectively be performed after step 216 in order to analyze individual action potentials based on individual leading baselines.

### Raw and Derivative Biological Response Curves

As discussed above, the baseline measurement determination system 158 determines a baseline measurement based on a derivative biological response curve of a raw biological response curve. An example of a raw waveform 250 for raw biological response data (i.e., a raw biological response curve) is shown in FIG. 4A. The derivative waveform 252 (i.e., the derivative biological response curve) for the raw waveform of FIG. 4A is shown in FIG. 4B. The derivative waveform 252 in FIG. 4B has been smoothed by a smoothing module 174.

As mentioned above, a smoothing module 174 may smooth the derivative waveform 252. Smoothing the derivative waveform 252 reduces noise that may be present in the derivative waveform. The size of a smoothing window used to smooth derivative waveforms may be an integer value and may be a user-configurable user preference. The user interface 162 may receive the size of the smoothing window as user input, and the data store 160 may store the received smoothing window size as a user preference 166 as mentioned above. When smoothing the derivative waveform 252, the smoothing module 174 may use a default-sized smoothing window or retrieve the user-specified smoothing window size from the data store 160. A suitable smoothing approach may be, for example, a “fast” smoothing algorithm as described by Tom O'Haver of The University of Maryland at College Park at: http://terpconnectumd.edu/˜toh/spectrum/Smoothing.html.

As seen in FIG. 4A, the raw waveform 252, in this example, graphs the magnitude of around eight-hundred sample points numbering from 1 to about 800 with magnitude values between around two hundred sixty and three hundred eighty. The raw waveform 252, in this example, includes four action potentials 254, and the action potentials 254 exhibit a two-step decay profile 256. As discussed above, the derivation module 172 determines the derivative of the raw waveform 250 to obtain a derivative waveform such as the derivative waveform 252 shown by way of example in FIG. 4B. As seen in FIG. 4B, the derivative waveform 252 also includes corresponding derivative sample points also numbering from 1 to about 800. The derivative sample points are respectively associated with a derivative magnitude value, which may be positive or negative in the derivative waveform 252. Derivative magnitude values may be associated with a positive or negative sign. In the derivative waveform 252 shown in FIG. 4B, for example, the derivative magnitude values are between around negative four and positive twelve. As discussed further below, the peak identification module 176 identifies peaks where the sign of the derivative waveform 252 changes from positive to negative.

### Peak Identification

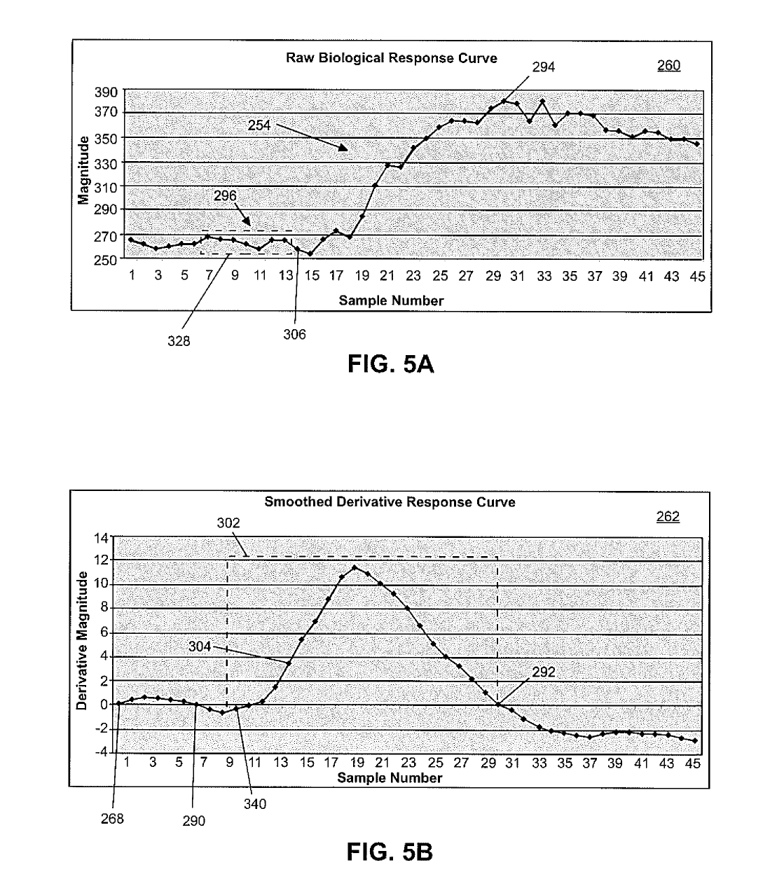

Peak identification will now be discussed with reference to FIG. 5A, FIG. 5B, and FIG. 6. For clarity, FIG. 5A and FIG. 5B include respective subsections 260 and 262 of the raw waveform 250 and derivative waveform 252 in FIG. 4A and FIG. 4B. As seen in FIG. 5A and FIG. 5B, only sample points 1 through 45 are shown, which correspond to the first action potential 254 in FIG. 4A. In FIG. 6 a flowchart 264 of example method steps for identifying a peak in the raw waveform 260 based on the derivative waveform 262 is shown. As seen in FIG. 3 above, the peak identification module 176 may repeat the steps in FIG. 6 in order to identify multiple peaks in the raw waveform 250.

To identify a peak, the peak identification module 176 scans the derivative waveform 260 in a left-to-right direction and compares the signs of the respective derivative magnitudes for adjacent sample points. Where the sign of the derivative magnitude for a current sample point changes from positive to negative, the peak identification module 176 identifies the current sample point as being associated with a peak in the raw waveform 260.

As shown in FIG. 6, the peak identification module 176 begins by selecting a sample point in the derivative waveform 262, i.e., the current sample point (step 266). During the first iteration of the peak identification process, the first selected sample point will be the first sample point 268 of the derivative waveform 262, i.e., sample point number 1. During subsequent iterations of the peak identification process, the first selected sample point will be the sample point to the right of a previous sample point identified as being associated with a peak in the raw waveform 260, i.e., the rightwardly adjacent sample point.

The peak identification module 176 determines the sign of the derivative magnitude of the current sample point (step 270) as well as the sign of the derivative magnitude of the sample point to the right of the current sample point (step 272). The peak identification module 176 then compares the signs of the respective derivative magnitudes for the current sample point and rightward sample point (step 274) and determines whether the derivative waveform 262 changes from positive to negative at the current sample point (step 276). The derivative waveform 262 changes from positive to negative if the derivative magnitude of the current sample point is positive and the derivative magnitude of the rightward sample point is negative. If the signs of the derivative magnitudes are the same (i.e., both positive or both negative), then the derivative waveform 262 is not changing from positive to negative at the current sample point.

If the derivative waveform 262 changes from positive to negative at the current sample point, then the peak identification module 176 identifies the current sample point as being associated with a potential peak in the raw waveform 260. The threshold module 178 then compares the magnitude of the current sample point in the raw waveform 260 to the threshold magnitude cutoff (step 278). If the magnitude of the current sample point does not meet or exceed the magnitude threshold, then the threshold module 178 rejects the current sample point, and the peak identification module 178 does not identify the current sample point as being associated with a peak in the raw waveform 260. If the current sample point does meet or exceed the threshold cutoff, then the peak identification module 178 identifies the current sample point as being associated with a peak in the raw waveform 260 (step 280).

If the derivative waveform 262 is not changing from positive to negative or the potential peak does not meet or exceed the threshold cutoff, then the peak identification module 176 determines if there are any remaining sample points in the derivative waveform 262 to analyze (step 282). If there are additional sample points to analyze in the derivative waveform 262, the peak identification module 176 selects the rightward sample as the current sample (step 284) and repeats steps 270-278 to identify any additional peaks in the raw waveform 260. If the derivative waveform 262 does not include any remaining sample points to analyze, then the peak identification module 176 may conclude the search of the derivative waveform 262 for a peak in the raw waveform 260 (step 286).

The example raw waveform 260 shown in FIG. 5A and the example derivative waveform 262 shown in FIG. 5B provide an example of peak identification. Moving from left to right, the example derivative waveform 262 shown in FIG. 5B changes from positive to negative at two different sample points 290 and 292, i.e., sample number 7 and sample number 30. Accordingly the peak identification module 176 may identify sample number 7 and sample number 30 as potential peaks in the raw waveform 260. As seen in the example raw waveform 260 shown in FIG. 5A, sample number 7 has a magnitude of around two hundred seventy, and sample number 30 has a magnitude of around three hundred eighty.

The threshold module 178, in this example, may determine that sample number 7 does not meet or exceed the cutoff magnitude threshold, and may determine that sample number 30 does exceed the cutoff magnitude threshold. As a result the peak identification module 176 may reject sample number 7 as a peak in the raw waveform 260 and confirm sample number 30 as a peak 294 in the raw waveform 260. Accordingly sample number 30, in this example, is associated with the peak 294 for the action potential 254 in the raw waveform 260.

Once the peak identification module 176 has identified a peak in the raw waveform 260, the leading baseline identification module 180 searches the derivative waveform 262 to identify the leading baseline 296 for the action potential 254 in the raw waveform 260.

### Leading Baseline Identification

Leading baseline identification will now be discussed with reference to FIG. 5A, FIG. 5B, and FIG. 7. In FIG. 7 a flowchart 300 of example method steps for identifying the start of an action potential 254 is shown. The leading baseline identification module 180, in this example, identifies a leading baseline 296 for an action potential 254 in the raw waveform 260 and determines a magnitude value for that leading baseline 296. As discussed above, an action potentials 254 in the raw waveform 260 is associated with a peak 294 identified by the peak identification module 176.

To identify the leading baseline 296 for an action potential 254 in the raw waveform 260, the leading baseline identification module 180 searches the derivative waveform 262 in a right-to-left direction starting at the sample point 292 associated with the identified peak 294 of the action potential 254. The leading baseline identification module 180 calculates the difference between the derivative magnitudes of adjacent sample points in a search window 302. The search window 302 starts at the sample point 292 (e.g., sample number 30) where the derivative waveform 262 changes from positive to negative. The search window 302 extends to the left of sample point 292 to include one or more sample points leftward of sample point 292. The leading baseline identification module 180 identifies a sample point 304 in the derivative waveform 262 that is associated with the largest positive change in the derivative magnitude, i.e., the maximum change in derivative magnitude. The leading baseline identification module 180 identifies the sample point 304 associated with the largest positive change in derivative magnitude as the starting position 306 of the action potential 254 in the raw waveform 260. The leading baseline identification module 180, in this example, then identifies the leading baseline 296 for the action potential 254 based on the starting position 306 of the action potential 254.

As an alternative approach, the leading baseline identification module 180 may identify the starting position 306 of the action potential 154 in the raw waveform 260 based on the second derivative of the raw waveform 260. In this alternative approach, the leading baseline identification module 180 searches the second derivative for the sample point corresponding to the largest amplitude leftward of an identified peak 294. The leading baseline identification module 180 identifies the sample point in the second derivative corresponding to the largest amplitude leftward of the identified peak 294 as the start of the action potential 154 associated with the peak.

As seen in FIG. 7, the leading baseline identification module 180, in this example, first selects as the current sample point the sample point 292 in the derivative waveform 262 that is associated with an identified peak 294 in the raw waveform 260 (step 310). The leading baseline identification module 180 then determines the derivative magnitude of the sample point to the left of the current sample point (step 312), i.e., the leftwardly adjacent sample point. The leading baseline identification module 180 determines the difference between the respective derivative magnitudes of the current sample point and the leftward sample point (step 314). The difference in respective magnitudes represents the current change in the derivative magnitude between the current sample point and the leftwardly adjacent sample point.

The leading baseline identification module 180, in this example, may store the value of the largest difference, i.e., the largest positive change in derivative magnitude, at the data store 160 during the leading baseline identification process. The leading baseline identification module 180 may initialize the value of the largest positive change to a minimal value, e.g., zero. If the leading baseline identification module 180 determines that the current difference in derivative magnitude between a current sample point and a leftward sample point is larger than the stored value of the largest difference (step 316), then the leading baseline identification module 180 may replace the value of the stored largest difference with the value of the current difference by setting the value of the stored largest difference to the value of the current difference (step 318). In some example implementations, the leading baseline identification module 180 may not store (i.e., discard) difference values that are negative. The leading baseline identification module 180 may also store the sample number of the sample point associated with the largest difference.

The leading baseline identification module 180, in this example, then continues the right-to-left search of the derivative waveform 262 until a stop condition is satisfied (step 320). The leading baseline identification module 180 may stop searching the derivative waveform 262 for the starting position 306 of the action potential 254 if one of the following events occurs: the sign of the derivative waveform 262 changes from positive to negative when searching from right to left; the sample point associated with a previously detected peak is reached; or the first sample point 268 of the derivative waveform 262 is reached. Accordingly the leading baseline identification module 180 also compares the signs of the current sample point and the leftward sample point to determine if the derivative waveform 262 changes from positive to negative while scanning in a right-to-left direction.

If a stop condition is not satisfied, the leading baseline identification module 180, in this example, selects the sample point to the left of the current sample point as the new current sample point (step 322). The leading baseline identification module may then repeat steps 312-320 to continue the search for the starting position 306 of the action potential 254 in the raw waveform 260 or to continue until a stop condition is satisfied.

When a stop condition is satisfied, the leading baseline identification module 180 may determine if a sufficient number of sample points were searched in order to identify the start of the action potential 254 (step 324). If the leading baseline identification module did not search a sufficient number of sample points, i.e., if the search window 328 does not include a sufficient number of sample points, then the module 180 may not identify a starting point for the action potential 254 and conclude the search for the start of the action potential 254 (step 326). If the leading baseline identification module 180 does not identify a starting position 306 for the action potential 254, then the leading baseline identification module 180 may also not identify a leading baseline 296 for the action potential 254. The number of sample points used to identify the starting position 306 of the action potential 254 may be a user-configurable setting and stored at the data store 160 as a user preference 166; a suitable number of sample points may be, for example, around 3-50 sample points.

If the leading baseline identification module 180 does search a sufficient number of sample points (step 324), i.e., if the search window 328 includes a sufficient number of sample points, then the module 180 identifies the sample point associated with the stored largest difference as the starting position 306 of the action potential 254 (step 326).

Having identified the starting position 306 of the action potential 254, the leading baseline identification module 180, in this example, determines a magnitude value of the leading baseline 296 for the action potential. 254 The leading baseline identification module 180 determines a magnitude for the leading baseline 296 by averaging the magnitudes of sample points in the raw waveform 260 to the left of the sample point identified as the starting position 306 of the action potential 254.

The leading baseline identification module 180, in this example, may average the magnitudes of sample points in the raw waveform 260 that fall within an averaging window 328 positioned to the left (i.e., leftward) of the sample point identified as the starting position 306 of the action potential 254. The size of the averaging window 328, i.e., the number of sample points used to determine the average magnitude of the leading baseline 296, may be a default value or a user-specified value. The size of the averaging window 328 may be received at the user interface 162 and stored at the data store 160 as a user preference. When identifying the leading baseline 296, the leading baseline identification module 180 may determine the size of the averaging window 328 (step 330) in order to select the sample points that fall within the average window 328.

The leading baseline identification module 180, in this example, may also determine whether the averaging window 328 includes a sufficient amount of sample points to determine an average magnitude of the leading baseline 296 (step 332). A sufficient amount of sample points to calculate an average magnitude of the leading baseline 296 may be, for example, 1-10 sample points. If the averaging window 328 includes an insufficient amount of sample points, then the leading baseline identification module 180 may identify the magnitude of the sample point associated with the starting position 306 of the action potential 254 as the magnitude of the leading baseline 296 for the action potential 254 (step 334). If the averaging window 328 includes a sufficient amount of sample points, then the leading baseline identification module 180 may calculate the average magnitude of the sample points that fall within the averaging window 328 (step 336) and identify the average magnitude of the sample points within the averaging window 328 as the magnitude of the leading baseline 296 for the action potential 294 (step 338).

The leading baseline identification module may repeat steps 310-338 to identify respective leading baselines 296 and respective magnitudes for each of the action potentials 254 in the raw waveform 260.

The example raw waveform 260 and the example derivative waveform 262 respectively shown in FIG. 5A and FIG. 5B provide an example of leading baseline identification. Continuing the example above, sample number 30 in FIG. 5A and FIG. 5B may be identified as a peak 294 associated with an action potential 254.

The leading baseline identification module 180 may thus search the derivative waveform 262 from right to left starting at sample point 292 (i.e., sample number 30) in order to identify the starting position 306 of the action potential 254 in the raw waveform 260. The leading baseline identification module 180 identifies the starting position 306 of the action potential 254 as the sample point 304 associated with the largest positive change, i.e., difference, in derivative magnitude occurs. Scanning the derivative waveform 262 from right to left, the leading baseline identification module 180 may compare the derivative magnitudes of adjacent sample points, e.g.: sample number 29 and sample number 28; sample number 28 and sample number 27; sample number 27 and sample number 26, etc. At each comparison, the leading baseline determination module 180 determines if the difference in derivative magnitude is larger than the stored largest difference. If the difference in derivative magnitude is greater than the stored largest difference, then the leading baseline identification module 180 stores the difference in derivative magnitude as the new largest difference as well as the sample number associated with the largest difference. The largest difference in derivative magnitude occurs, in this example, between sample number 13 and sample number 14. Accordingly the leading baseline identification module 180 may identify sample point 304 (i.e., sample number 14) as the starting position 306 of the action potential 254 in the raw waveform 260.

The leading baseline determination module 180 may stop searching for the starting position 306 of the action potential 254 when a stop condition is satisfied. A stop condition, in this example, is satisfied when the sign of the derivative waveform 262 changes from positive to negative. As seen in the example derivative waveform 262 of FIG. 5B, the derivative waveform 262 changes from positive to negative at sample point 340, i.e., between sample number 11 and sample number 10.

Having identified sample point 304 as the starting position 306 of the action potential 254 in the raw waveform 260, the leading baseline identification module 180 may then determine an average magnitude of the leading baseline 296 for the action potential 254 in the raw waveform 260. The averaging window 328, in this example, may include sample numbers 7-13. The leading baseline identification module 180 may thus average the magnitudes of sample numbers 7-13 in the raw waveform 260 to determine a magnitude value for the leading baseline 296 of the action potential 254.

As discussed above in reference to FIG. 3, the baseline determination module 182 may determine a baseline measurement for the raw waveform 260 based on the leading baselines 296 for action potentials 254 in the raw waveform 260. The baseline determination module 182, in this example, averages the magnitudes of the leading baselines 296 in order to determine a magnitude for an overall baseline measurement of the raw waveform 260. An action potential analysis module 170 of the control system 156 may advantageously use the baseline measurement of the raw waveform 260 when analyzing properties relating to action potentials 254 in the raw waveform 260. The action potential analysis module 170 may use the baseline measurements when determining rise time, decay time, and width properties of action potentials 254 in the raw waveform 260. For example, maximum amplitude of an action potential 254 in the raw waveform 260 may be determined relative to the baseline 296 associated with the action potential 254. As another example, maximum width of the action potential 254 in the raw waveform 260 may be defined as a time difference between sample points at a percentage of the maximum amplitude, e.g., 10% or 50% of the maximum amplitude.

It will be understood and appreciated that one or more of the processes, sub-processes, and process steps described in connection with FIGS. 2-3 and 6-7 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIGS. 2-3 and 6-7. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., a baseline determination system in FIG. 2), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A computer-implemented method of determining a baseline measurement for a biological response curve comprising the steps of:
determining a derivative response curve based on the biological response curve;
searching the derivative response curve to identify a peak in the biological response curve;
searching the derivative response curve to identify a starting position of the peak;
identifying a leading baseline in the biological response curve, the leading baseline is associated with the peak and is identified based at least in part on the starting position of the peak; and
determining a baseline measurement for the biological response curve based at least in part on the leading baseline associated with the peak,
wherein each step is performed by one or more modules of a system for determining the baseline measurement for the biological response curve.

2. The computer-implemented method of claim 1 wherein searching the derivative response curve to identify a peak in the biological response curve further comprises:
scanning the derivative response curve in a left-to-right direction;
determining that a sign of the derivative response curve changes from positive to negative; and
identifying the peak in the biological response curve based at least in part on the change of the sign of the derivative response curve from positive to negative.

3. The computer-implemented method of claim 2 wherein the derivative response curve includes a plurality of sample points, the sample points are respectively associated with a positive or negative sign, and determining that the sign of the derivative response curve changes from positive to negative further comprises:
comparing the sign of a sample point to the sign of a rightwardly adjacent sample point;
determining that the sign of the sample point is positive;
determining that the sign of the rightwardly adjacent sample point is negative; and
identifying the sample point as being associated with the peak in the biological response curve.

4. The computer-implemented method of claim 2 further comprising:
determining a magnitude threshold;
comparing a magnitude of an identified peak to the magnitude threshold;
determining that the identified peak is associated with an action potential in the biological response curve where the magnitude of the identified peak is at least equal to the magnitude threshold; and
determining that the identified peak is not associated with an action potential in the biological response curve where the magnitude of the identified peak is not at least equal to the magnitude threshold.

5. The computer-implemented method of claim 1 wherein searching the derivative response curve to identify the starting position of the peak further comprises:
scanning the derivative response curve in a right-to-left direction; and
identifying the starting position of the peak based at least in part on a maximum change in derivative magnitude of the derivative response curve.

6. The computer-implemented method of claim 5 wherein the derivative response curve includes a plurality of sample points, the sample points are respectively associated with a derivative magnitude, and identifying the starting position of the peak further comprises:
determining a current change in derivative magnitude based on a difference between derivative magnitudes respectively associated with a sample point and a leftwardly adjacent sample point;
determining whether the current change in derivative magnitude is larger than the maximum change in derivative magnitude;
setting the maximum change in derivative magnitude to the current change in derivative magnitude in response to a determination that the current change in derivative magnitude is larger than the maximum change in derivative magnitude; and
identifying the sample point associated with the maximum change in derivative magnitude as the starting point of the peak in response to a determination that a stop condition is satisfied.

7. The computer-implemented method of claim 1 wherein the biological response curve includes a plurality of sample points, the sample points are respectively associated with a magnitude, and identifying the leading baseline for the peak further comprises:
identifying one or more sample points that fall within an averaging window leftward of the start of the peak;
determining an average magnitude of the magnitudes respectively associated with the sample points that fall within the averaging window; and
identifying the leading baseline for the peak based at least in part on the average magnitude.

8. The computer-implemented method of claim 1 further comprising smoothing the derivative response curve such that noise in the derivative response curve is reduced.

9. The computer-implemented method of claim 1 wherein the biological response curve includes a plurality of peaks and the determination of the baseline measurement for the biological response curve is based at least in part on a plurality of leading baselines respectively associated with the plurality of peaks.

10. The computer-implemented method of 9 wherein the plurality of peaks are respectively associated with a plurality of action potentials in the biological response curve and further comprising analyzing one or more respective properties of the plurality of action potentials in the biological response curve using the baseline measurement for the biological response curve.

11. A system for determining a baseline measurement for a biological response curve comprising:
a derivation module that determines a derivative response curve based on the biological response curve;
a peak identification module that searches the derivative response curve to identify a peak in the biological response curve;
a leading baseline identification module that searches the derivative response curve to identify a starting position of the peak and identifies a leading baseline in the biological response curve, the leading baseline is associated with the peak and is identified based at least in part on the starting position of the peak; and
a baseline determination module that determines a baseline measurement for the biological response curve based at least in part on the leading baseline associated with the peak.

12. The system of claim 11 wherein the peak identification module:
scans the derivative response curve in a left-to-right direction;
determines that a sign of the derivative response curve changes from positive to negative; and
identifies the peak in the biological response curve based at least in part on the change of the sign of the derivative response curve from positive to negative.

13. The system of claim 12 wherein the derivative response curve includes a plurality of sample points, the sample points are respectively associated with a positive or negative sign, and the peak identification module:
compares the sign of a sample point to the sign of a rightwardly adjacent sample point; and
identifies the sample point as associated with the peak in the biological response curve in response to a determination that the sign of the sample point is positive and the sign of the rightwardly adjacent sample point is negative.

14. The system of claim 12 further comprising a threshold module that:
determines a magnitude threshold;
compares a magnitude of an identified peak to the magnitude threshold;
determines that the identified peak is associated with an action potential in the biological response curve where the magnitude of the identified peak is at least equal to the magnitude threshold; and
determines that the identified peak is not associated with an action potential in the biological response curve where the magnitude of the identified peak is not at least equal to the magnitude threshold.

15. The system of claim 11 wherein the leading baseline identification module:
scans the derivative response curve in a right-to-left direction; and
identifies the starting position of the action potential based at least in part on a maximum change in derivative magnitude of the derivative response curve.

16. The system of claim 15 wherein the derivative response curve includes a plurality of sample points, the sample points are respectively associated with a derivative magnitude, and the leading baseline identification module:
determines a current change in derivative magnitude based on a difference between derivative magnitudes respectively associated with a sample point and a leftwardly adjacent sample point;
determines whether the current change in derivative magnitude is larger than the maximum change in derivative magnitude;
sets the maximum change in derivative magnitude to the current change in derivative magnitude in response to a determination that the current change in derivative magnitude is larger than the maximum change in derivative magnitude; and
identifies the sample point associated with the maximum change in derivative magnitude as the starting point of the peak in response to a determination that a stop condition is satisfied.

17. The system of claim 11 wherein the biological response curve includes a plurality of sample points, the sample points respectively associated with a magnitude, and the leading baseline identification module:
identifies one or more sample points that fall within an averaging window leftward of the start of the peak;
determines an average magnitude of the magnitudes respectively associated with the sample points that fall within the averaging window; and
identifies the leading baseline for the peak based at least in part on the average magnitude.

18. The system of claim 11 further comprising a smoothing module that smoothes the derivative response curve such that noise in the derivative response is reduced.

19. The system of claim 11 wherein the biological response curve includes a plurality of peaks and the determination of the baseline measurement for the biological response curve is based at least in part on a plurality of leading baselines respectively associated with the plurality of peaks.

20. The system of claim 19 wherein the plurality of peaks are respectively associated with a plurality of action potentials in the biological response curve and the baseline measurement for the biological response curve is provided to an action potential analysis module for analysis of one or more respective properties of the plurality of action potentials in the biological response curve using the baseline measurement for the biological response curve.
